(19) United States
(12) Patent Application Publication
(10) Pub. No.: US 2022/0050941 A1
(43) Pub. Date: Feb. 17, 2022

(54) METHOD FOR SOLVING COMPLETE FLUTTER TERMINATION PARAMETER BASED ON DOUBLE MASS BODIES OF NON-FIXED CONSTRAINT

(71) Applicant: UNIVERSITY OF SHANGHAI FOR SCIENCE AND TECHNOLOGY, Shanghai (CN)

(72) Inventors: Yanchen Du, Shanghai (CN); Hongyuan Zhang, Shanghai (CN); Junwen Lin, Shanghai (CN)

(21) Appl. No.: 17/056,187

(22) PCT Filed: Apr. 13, 2020
(86) PCT No.: PCT/CN2020/084541

§ 371 Date: Nov. 17, 2020

(30) Foreign Application Priority Data
Apr. 24, 2019 (CN) 2019103326265

(51) Int. Cl. G06F 30/20

(52) U.S. Cl. CPC G06F 30/20; G06F 2111/10

(57) ABSTRACT

The present invention proposes a method for solving a complete flutter termination parameter based on double mass bodies of non-fixed constraint, including the following steps: obtain model input parameters at a flutter termination moment t0, wherein the model input parameters includes the mass ratio of the double mass bodies as well as position coordinates, a speed, an acceleration speed and a restoration coefficient of each mass body, the mass ratio and the restoration coefficient are both constants; establish a first solution model to obtain a parameter at a flutter termination moment t^{∞}; establish a second solution model to obtain position parameters of the double mass bodies at the flutter termination moment t^{∞}; establish a third solution model to obtain speed parameters of the double mass bodies at the flutter termination moment t^{∞} according to the third solution model and the model input parameters. The present invention continues to complete numerical simulation directly from a certain flutter moment, can skip over a flutter process, and directly obtain the flutter termination moment and the positions and speeds of the double collision mass bodies at the flutter termination moment, thereby improving calculation accuracy and saving a lot of calculation time.

### FIELD OF THE INVENTION

The present invention belongs to the field of numerical simulation of mechanical motion, and particularly relates to a method for solving a complete flutter termination parameter based on double mass bodies of non-fixed constraint.

### BACKGROUND OF THE INVENTION

Collision is an inevitable phenomenon in the process of mechanical movement. Due to a resilience force, a repeated small-amplitude collision often occurs, and is usually called flutter. A flutter process continues until the two collision mass bodies move completely synchronously and become viscous, which is called complete flutter. Complete flutter means countless collisions, which brings great difficulties to numerical simulation. This is mainly manifested in: (1) a small amplitude of the flutter, and a large rounding error of the numerical simulation; (2) a plurality of collisions, and easy entry into an endless loop; (3) if a small amplitude collision is ignored, an error caused is not negligible. At present, there has been a preliminary solution for the collision with fixed constraint, that is, the situation where one of the double mass bodies participating in the collision is fixed.

But for the most common situation where double collision mass bodies do not belong to non-fixed constraint, due to a complex motion process, an extremely simplified method is often used to simulate, resulting in the following defects: (1) a smaller flutter motion is directly ignored, resulting in a large final error result; (2) calculation time is increased for the above-mentioned smaller flutter motion, resulting in long calculation time and low efficiency. Therefore, there is no effective way to solve the defects in a simulation process, and the problem of non-fixed constrained flutter simulation has become a technical bottleneck in the field of collision research.

### SUMMARY OF THE INVENTION

The objective of the present invention is to provide a method for solving a complete flutter termination parameter based on double mass bodies of non-fixed constraint, which can skip over a flutter process, and directly obtain a flutter termination moment and the positions and speeds of the two collision mass bodies at the flutter termination moment, thereby being able to make the simulation calculation go beyond an endless loop and greatly improve calculation accuracy. In order to achieve the above objective, the present invention adopts the following technical solution:

1. A method for solving a complete flutter termination parameter based on double mass bodies of non-fixed constraint, comprising the following steps:

Step S1: obtain model input parameters at a flutter termination moment t0, wherein the model input parameters comprises the mass ratio of the double mass bodies as well as position coordinates, a speed, an acceleration speed and a restoration coefficient of each mass body, and the mass ratio and the restoration coefficient are both constants;

Step S2: establish a first solution model to obtain a parameter at a flutter termination moment t^{∞} according to the first solution model and the model input parameters;

Step S3: establish a second solution model to obtain position parameters of the double mass bodies at the flutter termination moment t^{∞} according to the second solution model and the model input parameters;

Step S4: establish a third solution model to obtain speed parameters of the double mass bodies at the flutter termination moment t^{∞} according to the third solution model and the model input parameters;

Preferably, in step S2, the first solution model is as follows:

$${t}_{∞} = {t}_{0} + \frac{2 r ( {\ddot{x}}_{0} - {\ddot{y}}_{0} )}{1 - r ( {\ddot{x}}_{0} - {\ddot{y}}_{0} )}$$

Preferably, in step S3, the second solution model is as follows:

$$\text{?} = {x}_{0} + \frac{( \text{?} - \text{?} )}{( \text{?} {\ddot{x}}_{0} - {\ddot{y}}_{0} {\text{?}}^{\text{?}} )} \frac{2 r}{{( 1 - r )}^{2}} [ \frac{r ( \text{?} \text{?} - \text{?} \text{?} )}{( \text{?} {\ddot{x}}_{0} - {\ddot{y}}_{0} )} + \frac{\text{?} \text{?} \text{?}}{( 1 + \text{?} )} ] , \\ \text{?} = \text{?} + \frac{( \text{?} - \text{?} )}{( \text{?} - \text{?} )} \frac{2 r}{{( 1 - r )}^{2}} [ \frac{r ( \text{?} \text{?} - \text{?} \text{?} )}{( \text{?} - \text{?} )} + \frac{\text{?} + \text{?} \text{?}}{( 1 + \text{?} )} ] . \\ \text{?} \text{indicates text missing or illegible when filed}$$

Preferably, in step S4, the third solution model is as follows:

$$\text{?} = \text{?} = \frac{\begin{matrix}[ ( 1 + r ) \text{?} + ( 2 r \text{?} + r - 1 ) \text{?} ] \text{?} - \\ [ 1 + r ) \text{?} \text{?} + ( 2 r + r \text{?} - \text{?} ) {\ddot{x}}_{0} ] {\ddot{y}}_{0}\end{matrix}}{( 1 - r ) ( 1 + \text{?} ) ( {\ddot{x}}_{0} - {\ddot{y}}_{0} )}$$

$$\text{?} \text{indicates text missing or illegible when filed}$$

Preferably, the restoration coefficient has a value range of 0 to 1.

Compared with the prior art, the present invention has the advantages that the numerical simulation can be completed directly from a certain flutter moment, the flutter process can be skipped, and the moment when the flutter ends and the positions and speeds of the two collision mass bodies at that moment can be directly obtained. Thereby improving calculation accuracy and saving a lot of calculation moment.

### BRIEF DESCRIPTION OF THE DRAWINGS

FIG. 1 is a flowchart of a method for solving a complete flutter termination parameter based on a double mass bodies of non-fixed constraint according to an embodiment of the present invention;

FIG. 2 is a diagram of a spring mass system according to an embodiment of the invention;

FIG. 3 is a curve of a relative displacement of double mass bodies as a function of time in an embodiment of the present invention;

FIG. 4 is a curve of a relative speed of double mass bodies with a change of time in an embodiment of the present invention.

1—Spring, 2—Car, 3—Ball, 4—Cavity.

### DETAILED DESCRIPTION OF THE INVENTION

A method for solving a complete flutter termination parameter based on double mass bodies of non-fixed constraint of the present invention will be described in more detail below in conjunction with drawings. A preferred embodiment of the present invention is shown. It should be understood that the person skilled in the art can modify the present invention of the description herein and still achieves the advantageous effects of the present invention. Therefore, the following description should be understood to be widely known to the person skilled in the art, and not as a limitation to the present invention.

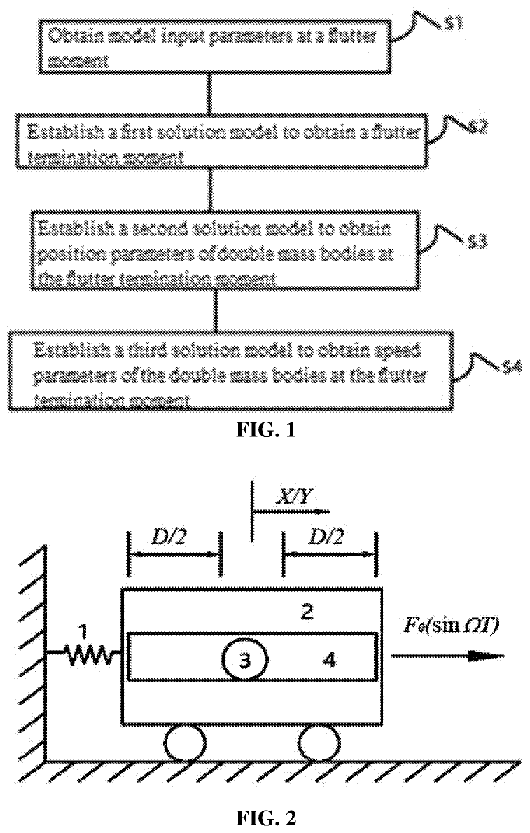

As shown in FIG. 1, a method for solving a complete flutter termination parameter based on double mass bodies of non-fixed constraint comprises steps S1 to S4, which are specifically as follows:

Step S1: obtain model input parameters at a flutter moment t₀: the mass ratio μm=M_{y}/Mₓ of the double mass bodies, position coordinates x₀ and y₀ of each mass body, the velocities x̋₀ and y̋₀, acceleration velocities x̋₀ and y̋₀, and a restoration coefficient r. The mass ratio and the restoration coefficient are both constants. In the case of flutter, the relative speed of the two collision mass bodies at a moment to is already very small. Therefore, the time from t₀ to a flutter termination moment is very short. The changes in the acceleration velocities x̋₀ and y̋₀ of the double collision mass bodies can be ignored, and the acceleration velocities can be treated as constants. “⋅” represents the derivative with respect to time; the superscript “-” represents a moment before the collision.

Step S2: establish a first solution model to obtain a parameter at a flutter termination moment t_{∞} according to the first solution model and the model input parameters. The first solution model is shown in Equation (1):

$${t}_{∞} = {t}_{0} + \frac{2 r ( {\ddot{x}}_{0} - {\ddot{y}}_{0} )}{1 - r ( {\ddot{x}}_{0} - {\ddot{y}}_{0} )} \qquad ( 1 )$$

Step S3: establish a second solution model to obtain position parameters of the double mass bodies at the flutter termination moment t_{∞} according to the second solution model and model input parameters. The second solution model is as shown in Equations (2)˜(3):

$$\begin{matrix}\text{?} = \text{?} + \frac{( \text{?} - \text{?} )}{( \text{?} - \text{?} )} \frac{2 r}{{( 1 - r )}^{2}} [ \frac{r ( \text{?} \text{?} - \text{?} \text{?} )}{( \text{?} - \text{?} )} + \frac{\text{?} + \text{?} \text{?}}{( 1 + \text{?} )} ] , & ( 2 ) \\ \text{?} = \text{?} + \frac{( \text{?} - \text{?} )}{( \text{?} - \text{?} )} \frac{2 r}{{( 1 - r )}^{2}} [ \frac{r ( \text{?} \text{?} - \text{?} \text{?} )}{( \text{?} - \text{?} )} + \frac{\text{?} + \text{?} \text{?}}{( 1 + \text{?} )} ] . \\ \text{?} \text{indicates text missing or illegible when filed} & ( 3 )\end{matrix}$$

Step S4: establish a third solution model to obtain speed parameters of the double mass bodies at the flutter termination moment t_{∞0} according to the third solution model and the model input parameters. The third solution model is as follows:

$$\text{?} = \text{?} = \frac{\begin{matrix}[ ( 1 + r ) \text{?} + ( 2 r \text{?} + r - 1 ) \text{?} ] \text{?} - \\ [ 1 + r ) \text{?} \text{?} + ( 2 r + r \text{?} - \text{?} ) {\ddot{x}}_{0} ] \text{?}\end{matrix}}{( ( 1 - r ) ( 1 + \text{?} ) ( \text{?} - \text{?} ) )} \\ \text{?} \text{indicates text missing or illegible when filed} \qquad ( 4 )$$

In this embodiment, the restoration coefficient r has a value range of 0 to 1.

As shown in FIG. 2, a spring mass subsystem consists of double mass bodies of a spring 1 and a trolley 2. The mass of the trolley 2 is M. A small ball 3 is placed in a cavity 4 inside the trolley 2. The small ball 3 can move freely in a horizontal direction. The mass of the small ball 3 is m. The displacement of the trolley 2 is represented by x. The displacement of the small ball 3 is represented by y. A horizontal rightward direction is a positive direction. When the spring 1 is in an equilibrium position, an origin of x and y coordinates coincides with the center of the trolley 2. The stiffness K=1000N·m−1 of the spring 1 is provided. A damping coefficient C=10N·s·m−1 is provided. The mass M=10 kg of the trolley 2 is provided. The mass m=0.5 kg of the small ball 3 is provided. The free length of the cavity 4 of the trolley is 5 mm. An excitation force F0=100N is provided. An excitation frequency Ω=10 Hz is provided.

With a numerical simulation method in the prior art, it is found that the small ball 3 collides with the trolley 2 at a moment t=0.1181031 s. This moment is recorded as the moment t0. The motion parameters of the trolley 2 and the small ball 3 at this moment are shown in Table 1. With a numerical simulation method and the method of the present invention, respectively, the flutter termination moment t^{∞}=0.1379127 s is obtained. The motion parameters of the trolley 2 and the small ball 3 at this moment are also listed in Table 1.

TABLE 1
Initial parameters and termination parameters of flutter

| | | | t = t₀ | | |
|---|---|---|---|---|---|
| Initial | | Termination | Numerical | Method of the | Relative |
| parameters | t = t₀ | parameters | Simulation | present invention | errors |
| x₀ | 0.0229412 m | x∞ | 0.0331375 m | 0.0331205 m | 0.051% |
| y₀ | 0.0204412 m | y∞ | 0.0306375 m | 0.0306205 m | 0.055% |
| x̅₀̅ | 0.5014152 m/s | x̅_̅{̅∞̅}̅ | 0.0497371 m/s | 0.0497697 m/s | 0.065% |
| y̅₀̅ | 0.0225439 m/s | y̅_̅{̅∞̅}̅ | 0.0497371 m/s | 0.0497697 m/s | 0.065% |
| x̅₀ | 0.0009400 m/s² | t∞ | 0.1379127 s | 0.1378267 s | 0.062% |
| y̅₀ | 0 m/s | | | | |

It can be seen from Table 1 that the accuracy of the calculation results obtained by the method of the present invention is relatively high, and the relative errors of a displacement and the speed are both less than 0.07%. In terms of calculation time, when the numerical simulation is used, the calculation time of a single flutter is about 50 s while the method of the present invention can immediately obtain the motion parameters when the flutter terminates. Since the above-mentioned flutter process is repeated tens of millions of times in the numerical simulation, in general, the calculation efficiency can be greatly improved.

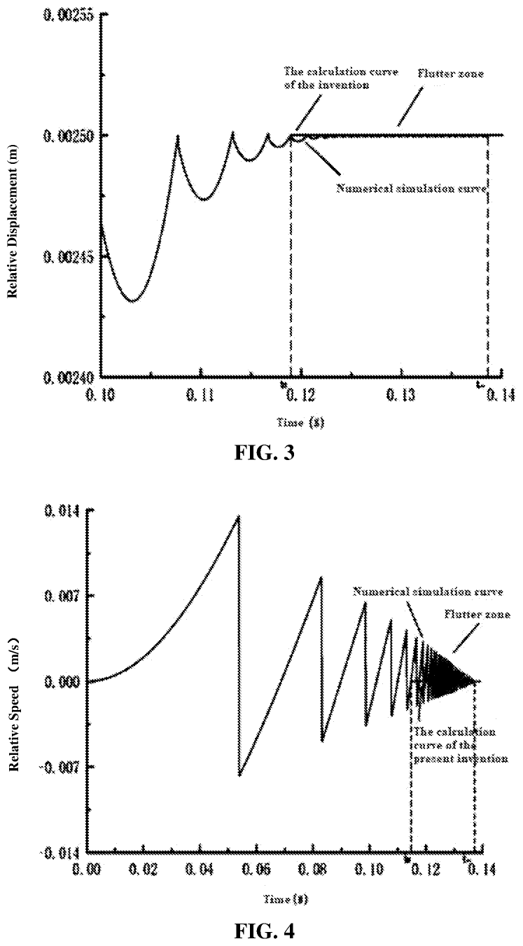

FIG. 3 shows a curve of a relative displacement (x−y) of the trolley 2 and the small ball 3 as a function of time. FIG. 4 shows a relative speed (\acute{x}−ý) of the trolley 2 and the small ball 3 as a function of time t. A curve part is a motion curve of a numerical simulation. A straight line part is a result of the termination parameter of the flutter motion directly given by the present invention. It can be seen from FIG. 3 and FIG. 4 that the present invention can immediately provide the flutter termination parameter, saving a lot of calculation time.

In this embodiment, the method has the following advantages: (1) the method is general and has a wide range of applications. This method can be applied to the situation where double collision mass bodies do not belong to fixed constraint, and the double collision mass bodies are allowed to have a variable acceleration speed. Therefore, the situation belongs to a general flutter collision situation. In addition, there are the following special cases: when a common small ball lands the ground, bounces and collides, the situation thereof belong to the situation of fixed constraint (earth) on one side and a fixed acceleration speed (the gravitational acceleration speed) on the other, which is a special case of the application of this method. When a general spring mass subsystem collides a fixed baffle, the situation thereof belongs to the situation of a fixed constraint (a baffle) on one side and the variable acceleration speed on the other, which is also a special case of the application of this method. In the above two situations, the mass ratio μm can be set to +∞, and an initial speed and an initial acceleration speed of fixed constraint can be set to 0. By using the method of the present invention to calculate, when the flutter terminates, the velocities of the two collision mass bodies are all 0, which converges to a solution of fixed constraint. Therefore, it can be considered that fixed constraint is a special situation of the present invention. The present invention is not limited by fixed constraint, can be applied to the most general non-fixed constraint, and hence has a wide range of applications.

(2) The method is fast and efficient in solution.

Equations (1)˜(4) only use the position, the speed and the acceleration speed at the moment t0, as well as the two constants r and μm. Therefore, at the moment t0, the moment when the collision flutter terminates and a position and speed of the two collision masses can be calculated. In the method in the prior art, in order to improve the calculation accuracy, an iteration step length is usually a small value, which leads to a large number of stepwise iterations and a long calculation time. The present invention achieves the final result in one step, and at the same time avoids the endless loop problem caused by the endless collision that is difficult to overcome in the traditional calculation.

(3) This method has high calculation accuracy and small error.

For a system with a constant acceleration speed, the present invention has no error. For a system with the variable acceleration speed, since the relative speed of the double collision mass bodies at moment t0 is small enough, the duration of the entire flutter process is small enough. It is feasible to assume that the acceleration speed does not change during this period. Generally speaking, as long as the change in the acceleration speed during flutter is less than 1%, the accuracy of the calculation result obtained by this method can be guaranteed. This is very necessary for the numerical simulation sensitive to an initial value, such as nonlinear collision.

In summary, for the method for solving the complete flutter termination parameter based on the double mass bodies of non-fixed constraint provided by an embodiment of the present invention, the numerical simulation can be completed directly from a certain flutter moment, and the flutter process can be skipped over to directly obtain the flutter termination moment and the position and speed of the double collision mass bodies at that flutter termination moment, thereby improving calculation accuracy and saving a lot of calculation time.

The foregoing are only preferred embodiments of the present invention, and do not play any restrictive effect on the present invention. The person skilled in the art, without departing from the scope of the technical solution of the present invention, makes any form of equivalent replacement, modification or other changes to the technical solution and technical content disclosed by the present invention, which does not depart from the content of technical solution of the present invention and still falls into the scope of protection of the present invention.

1. A method for solving a complete flutter termination parameter based on double mass bodies of non-fixed constraint, comprising the following steps:
Step S1: obtain model input parameters at a flutter termination moment t₀, wherein the model input parameters comprises the mass ratio of the double mass bodies as well as position coordinates, a speed, an acceleration speed and a restoration coefficient of each mass body, and the mass ratio and the restoration coefficient are both constants;
Step S2: establish a first solution model to obtain a parameter at a flutter termination moment t_{∞} according to the first solution model and the model input parameters;
Step S3: establish a second solution model to obtain position parameters of the double mass bodies at the flutter termination moment t_{∞} according to the second solution model and the model input parameters;
Step S4: establish a third solution model to obtain speed parameters of the double mass bodies at the flutter termination moment t_{∞} according to the third solution model and the model input parameters;

2. The method for solving the complete flutter termination parameter based on the double mass bodies of non-fixed constraint according to claim 1, wherein in step S2, the first solution model is as follows:
$${t}_{∞} = {t}_{0} + \frac{2 r ( {\ddot{x}}_{0} - {\ddot{y}}_{0} )}{1 - r ( {\ddot{x}}_{0} - {\ddot{y}}_{0} )}$$

3. The method for solving the complete flutter termination parameter based on the double mass bodies of non-fixed constraint according to claim 1, wherein in step S3, the second solution model is as follows:
$$\begin{matrix}\text{?} = \text{?} + \frac{( \text{?} - \text{?} )}{( \text{?} - \text{?} )} \frac{2 r}{{( 1 - r )}^{2}} [ \frac{r ( \text{?} \text{?} - \text{?} \text{?} )}{( \text{?} - \text{?} )} + \frac{\text{?} + \text{?} \text{?}}{( 1 + \text{?} )} ] , \\ \text{?} = \text{?} + \frac{( \text{?} - \text{?} )}{( \text{?} - \text{?} )} \frac{2 r}{{( 1 - r )}^{2}} [ \frac{r ( \text{?} \text{?} - \text{?} \text{?} )}{( \text{?} - \text{?} )} + \frac{\text{?} + \text{?} \text{?}}{( 1 + \text{?} )} ] . \\ \text{?} \text{indicates text missing or illegible when filed}\end{matrix}$$

4. The method for solving the complete flutter termination parameter based on the double mass bodies of non-fixed constraint according to claim 1, wherein in step S4, the third solution model is as follows:
$$\text{?} = \text{?} = \frac{\begin{matrix}[ ( 1 + r ) \text{?} + ( 2 r \text{?} + r - 1 ) {\ddot{y}}_{0} ] \text{?} - \\ [ 1 + r ) \text{?} \text{?} + ( 2 r + r \text{?} - \text{?} ) {\ddot{x}}_{0} ] {\ddot{y}}_{0}\end{matrix}}{( 1 - r ) ( 1 + \text{?} ) ( {\ddot{x}}_{0} - {\ddot{y}}_{0} )} . \\ \text{?} \text{indicates text missing or illegible when filed}$$

5. The method for solving the complete flutter termination parameter based on the double mass bodies of non-fixed constraint according to claim 1, wherein the restoration coefficient has a value range of 0 to 1.
